(19) United States
(12) Patent Application Publication
(10) Pub. No.: US 2013/0091751 A1
(43) Pub. Date: Apr. 18, 2013

(54) ADAPTER FOR ATTACHING A HAND GRIP TO A FIREARM

(71) Applicant: DIANE JEAN BARNEY, Abilene, TX (US)

(72) Inventor: DIANE JEAN BARNEY, Abilene, TX (US)

(21) Appl. No.: 13/275,867

(22) Filed: Oct. 18, 2011

(51) Int. Cl. F41C 23/00; B23P 11/00

(52) U.S. Cl. 42/71.01; 29/525.01

(57) ABSTRACT

An adapter for attaching a hand grip to the firearm without extensive modifications to the firearm stock or receiver includes a body having a first channel on the front face of the body and a second channel on the top end of the body. A hole passes from the bottom end of the body to the top end of the body. A step is placed on the bottom end of the body.

### BACKGROUND OF THE INVENTION

The present invention generally relates to accessory adapters for firearms. More particularly, the present invention relates to an adapter for attaching a hand grip to the firearm.

When shooting large caliber or automatic firearms, it is important that the firearm be maintained in a steady and stable position to insure accuracy of aim. In order to help control the firearm during firing, the prior art places pistol grips under the receiver and behind the trigger guard of the firearm. Unfortunately, securing the known pistol-style grips on the firearm requires the use of special tools, machining, and/or modification of the firearm stock or receiver.

As can be seen, there is a need for a device that allows a shooter to mount a hand grip on a firearm without extensive modifications to the firearm.

### SUMMARY OF THE INVENTION

In one aspect of the present invention, an adapter includes a body having a first channel on the front face of the body, a second channel on the top end of the body, a hole passing from the bottom end of the body to the top end of the body, and a step on the bottom end of the body.

In another aspect of the present invention, a method for attaching a hand grip to a firearm includes the steps of providing an adapter including a body, a first channel on the front face of the body, a second channel on the top end of the body, a hole passing from the bottom end of the body to the top end of the body, a step on the bottom end of the body, and a channel on the step; engaging the first channel with the back of the trigger guard of the firearm; securing the body to the firearm by passing a fastener through the hole in the body of the adapter and securing the fastener to the firearm; placing a nut in the channel of the step; and securing the hand grip to the adapter by coupling a second fastener with the nut.

These and other features, aspects and advantages of the present invention will become better understood with reference to the following drawings, description and claims.

### BRIEF DESCRIPTION OF THE DRAWINGS

FIG. 1 illustrates a perspective view of an adapter for attaching a hand grip to the firearm according to an exemplary embodiment of the present invention showing the adapter in a working position;

FIG. 2 illustrates an exploded view of the adapter of FIG. 1;

FIG. 3 illustrates a perspective front view of the adapter of FIG. 1;

FIG. 4 illustrates a back view of the adapter of FIG. 3;

FIG. 5 illustrates a right side view of the adapter of FIG. 3;

FIG. 6 illustrates a top front view of the adapter of FIG. 3;

FIG. 7 illustrates a left side view of the adapter of FIG. 3;

FIG. 8 illustrates a bottom view of the adapter of FIG. 3; and

FIG. 9 illustrates a front view of the adapter of FIG. 3.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide an adapter for attaching a hand grip to the firearm without extensive modifications to the firearm stock or receiver.

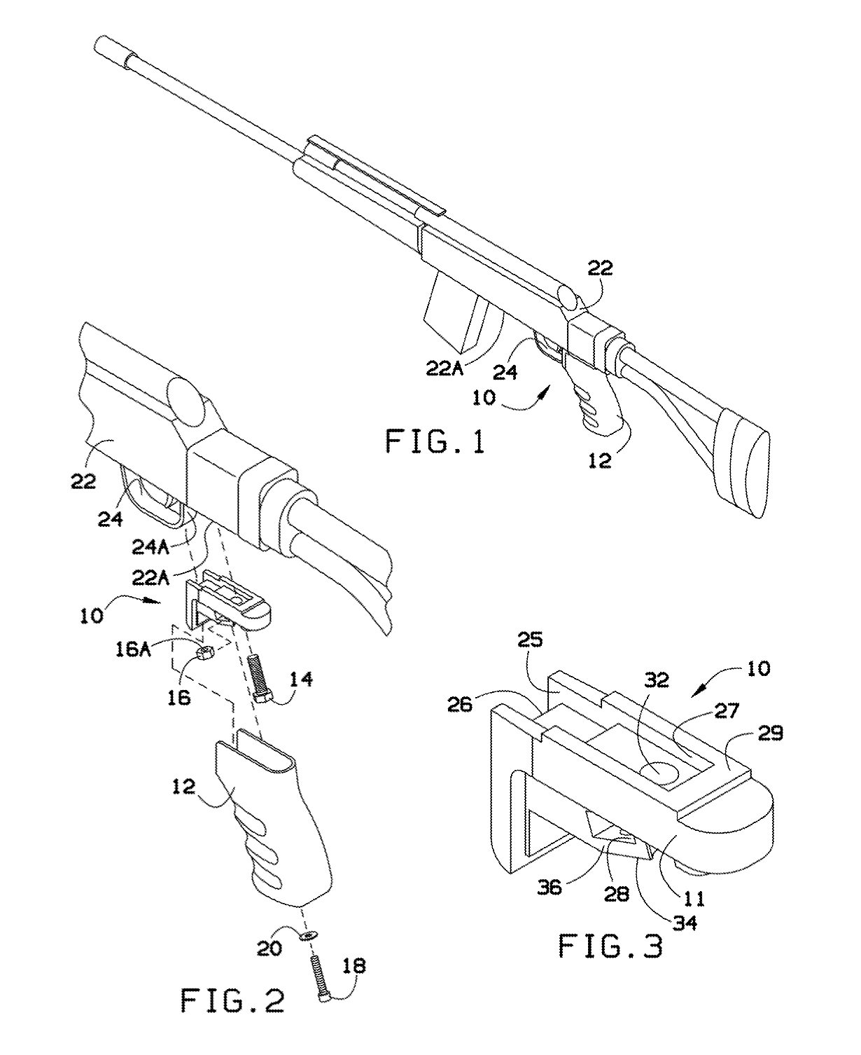

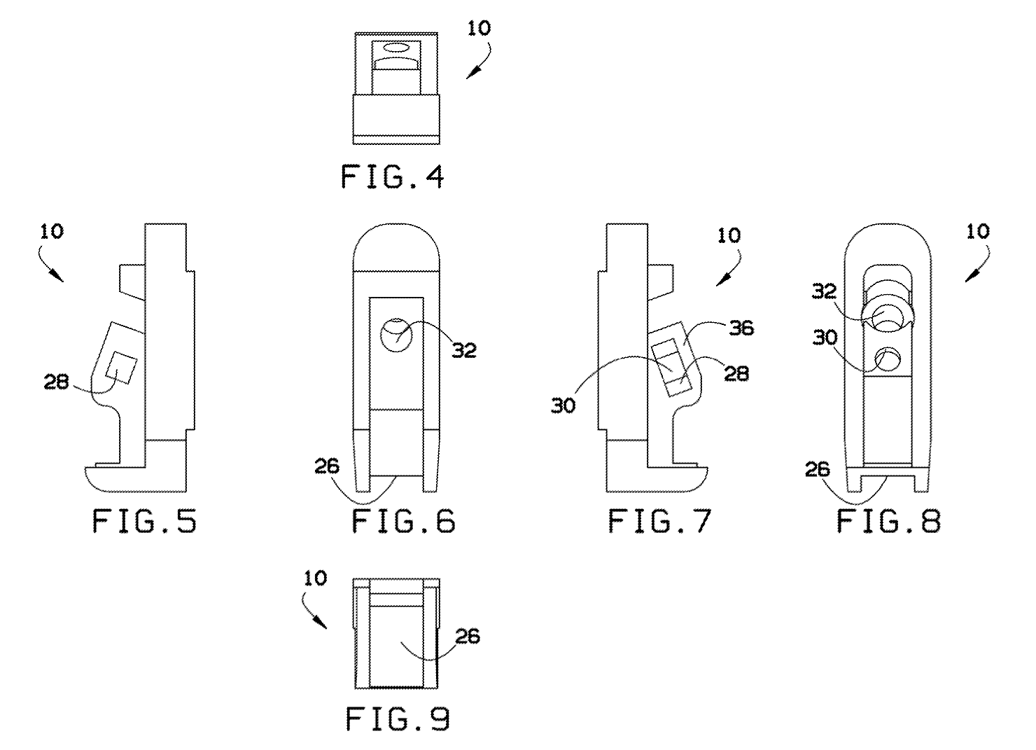

FIGS. 1-9 show an adapter 10 for attaching a hand grip 12 to a firearm 22 according to an exemplary embodiment of the present invention. The hand grip 12 may be placed near a trigger guard 24 of the firearm 22.

The adapter 10 may include a body 11 made of a sturdy material, for example, metal, plastic, wood, polymer, or composite. The size of the body 11 may depend on the type of firearm 22. The body 11 may be a unitary piece.

The body 11 may include a first channel 26 on its front face 25. The first channel 26 may be adapted to be engaged to the backside 24a of the trigger guard 24. The first channel 26 may prevent the adapter 10 from moving or rotating side to side. The shape of the first channel 26 may depend on the shape of the back side 24a of the trigger guard 24. The size of the first channel 26 may depend on the size of the trigger guard 24.

The body 11 may include a second channel 27 on its top end 29. The top end 29 of the body 11 may engage with a lower surface 22a of the firearm 22.

A hole 32 may be passed from a bottom end 34 to the top end 29 of the body 11. The hole 32 may pass through the body 11 at an angle. The angle may allow the hole 32 to align with an anchoring hole (not shown) normally located on the lower surface 22a of the firearm 22.

The adapter 10 may be secured to the lower surface 22a of the firearm 22 by passing a fastener 14 through the hole 32 and securing the fastener 14 on the anchoring hole (not shown) of the firearm 22. The fastener 14 may be, for example, a screw or bolt. In some embodiments, the fastener 14 may be a commercially available M8 1.25×30 mm cap screw.

The bottom end 34 of the body 11 may be adapted to engage with the hand grip 12. The bottom end 34 may include a step 36. The step 36 may be shaped to fit within the hand grip 12. The step 36 includes slanted walls. The step 36 may fit inside the hand grip 12. The step 36 may prevent the hand grip 12 from sliding or rotating side to side.

A channel 28 may be cut on the step 36. A nut 16 may be placed inside the channel 28. The nut 16 may include an orifice 16a that may be aligned with an opening 30 of the channel 28. The hand grip 12 may be secured to the adapter 10 by coupling a second fastener 18 with the nut 16. A washer 20 may be used to tighten the coupling between the second fastener 18 and the nut 16. The second fastener 18 may be a commercially available fastener for example a ¼″20×1″ cap screw. The size of the washer 20 may depend on the size of the second fastener 20.

The shooter (not shown) may engage the first channel 26 of the body 11 with the backside 24a of the trigger 24. Then, the shooter may bolt the body 11 to the lower surface 22a of the firearm 22 by using the fastener 14. Then, the shooter may place the nut 16 inside the channel 28 and secure the second fastener 18 to the nut 16.

The adapter 10 may allow the shooter to fire the firearm 22 by holding the hand grip 12 with his/her hand.

It should be understood, of course, that the foregoing relates to exemplary embodiments of the invention and that modifications may be made without departing from the spirit and scope of the invention as set forth in the following claims.

What is claimed is:

1. An adapter for attaching a hand grip to a firearm comprising:
a body having a front face, a back face, a top end, and a bottom end;
a first channel on the front face of the body;
a second channel on the top end of the body;
a hole passing from the bottom end of the body to the top end of the body;
a step on the bottom end of the body; and
a channel on the step.

2. The adapter according to claim 1, wherein the bottom end of the body is adapted to engage with the hand grip, wherein the top end of the body is adapted to engage with the firearm, and wherein the first channel is adapted to engage with a side of a trigger guard of the firearm.

3. The adapter according to claim 1, wherein the step includes slanted walls.

4. The adapter according to claim 1, further including a fastener to secure the adapter to the firearm.

5. The adapter according to claim 1, further including a nut placed on the channel of the step.

6. The adapter according to claim 5, further including a second fastener to secure the hand grip to the adapter, wherein the second fastener is screwed into a nut on the channel.

7. The adapter according to claim 1, wherein the body is a unitary piece.

8. A method for attaching a hand grip to a firearm comprising the steps of:
providing an adapter including a body having a front face, a back face, a top end, and a bottom end, a first channel on the front face of the body, a second channel on the top end of the body, a hole passing from the bottom end of the body to the top end of the body, a step on the bottom end of the body, and a channel on the step;
engaging the first channel with a side of a trigger guard of the firearm;
securing the body to the firearm by passing a fastener through an anchoring hole on the firearm;
placing a nut on the channel of the step; and
securing the hand grip to the adapter by coupling a second fastener with the nut.

9. The method according to claim 8, wherein the body is a unitary piece.
